(19) United States
(12) Patent Application Publication
(10) Pub. No.: US 2025/0180293 A1
(43) Pub. Date: Jun. 5, 2025

(54) HEATING COIL, IN PARTICULAR FOR A CURING OVEN IN MINERAL WOOL PRODUCTION

(71) Applicant: BERND MÜNSTERMANN GMBH & CO. KG, TELGTE (DE)

(72) Inventors: Simon STÄHLKER, WARENDORF (DE); Dietmar KOCH, NORDKIRCHEN (DE); Christian HAUTKAPPE, HERNE (DE); Georg OSTER, IBBENBÜREN (DE)

(21) Appl. No.: 18/962,226

(22) Filed: Nov. 27, 2024

(30) Foreign Application Priority Data
Dec. 1, 2023 (DE) 102023133640.1

(51) Int. Cl. F27B 9/30; F27B 9/36

(52) U.S. Cl. CPC F27B 9/3044; F27B 9/36

(57) ABSTRACT

A heating coil for an oven. The heating coil comprises a heat source for emitting energy, wherein the heating coil is configured so that a first fluid flows around the heat source. The heating coil further comprises a cleaning device having a nozzle pipe with a plurality of nozzles. A cleaning fluid emerges from the nozzles under overpressure compared to the first fluid and flows around the heat source to clean the heat source. The nozzles are arranged in at least two lines along the nozzle pipe and the at least two lines are spaced radially from one another along the nozzle pipe.

### CROSS-REFERENCES TO RELATED APPLICATIONS

This application claims the benefit of German Patent Application Number 102023133640.1 filed on Dec. 1, 2023, the entire disclosure of which is incorporated herein by way of reference.

### FIELD OF THE INVENTION

The invention relates to a heating coil, in particular for a curing oven in mineral wool production, through which a material web with a thermally curable binder passes.

### BACKGROUND OF THE INVENTION

In the production of insulating materials made of glass or rock wool, also known as mineral wool, for example, a binder added to the continuous mineral wool web is cured at temperatures of, for example, around 250° C. in a continuous curing oven. The mineral wool web is usually moved through the curing oven between two plate conveyor belts arranged one above the other. The plate conveyor belts also define the geometric properties of the end product insulation material, such as its thickness and surface finish.

Curing takes place by feeding hot air into the interior of the oven. For this purpose, the air is heated to the desired temperature in a heating coil. Such an oven is known, for example, from DE 10 2019 113 037 A1 of the applicant or EP 2 132 510 B1.

A heating coil, in particular for a curing oven, also known as a heat exchanger, comprises a heat source that can be formed in any way required. For example, it can be an arrangement of heating spirals or heating rods that are made of metal and that heat up when an electric current flows through them. A pipe system through which a fluid medium flows is also possible. This heating fluid is, for example, pressurized hot water. A first fluid or fluid medium flows around or rinses around the heat source. This first medium is, for example, normal ambient air, which is drawn in and conducted through the heating coil. It is understood that the pressure of the fluid flowing around the heat source, the desired input and output temperatures, the flow rate and the like can be selected according to the particular requirements. The same applies to the heat output of the heat source, which can be regulated, for example, by the strength of the current conducted through a heating spiral. The heating coil also has a housing for guiding the first fluid flowing around it, and has corresponding conveying devices such as fans or pumps, as well as a corresponding controller.

The heating coil can become clogged by deposits, particularly on the heat source around which the first fluid flows, by suspended particles, for example in the air conveyed through it, or by other impurities that are increasingly deposited on the outer surface of the heat source during operation, or the flow rate of the first fluid and thus the efficiency of the heating coil is reduced. This makes necessary an option for cleaning the heating coil, preferably during running operation, particularly of a curing oven.

For this purpose, a heat exchanger with a cleaning device is known from DE 29 23 875 A1. Here, hot steam is introduced into a first fluid, in this case water, also in pulsed fashion, in order to rinse the outside of a pipe system serving as a heat source by changing the pressure and temperature conditions, so that deposits on the pipe system are removed.

In addition, CN 212320075 U discloses a heating coil through which air flows, having a cleaning device. Here, pressurized air is applied to the outside of a pipe system through which heated air flows. This pressurized air comes from a cleaning pipe system, wherein a plurality of outlet nozzles are arranged in a line on a cleaning pipe and the pressurized air emerging from them is directed onto the pipe system. By continuously applying additional pressurized air to the actual pipe system as a heat source, deposits there are avoided or removed. However, the efficiency of the heating coil is reduced by the continuous application.

### SUMMARY OF THE INVENTION

The object of the present invention is therefore to provide a heating coil of the aforementioned type which avoids the above-mentioned disadvantages, but which nevertheless ensures adequate cleaning of the heat source during operation. Moreover, an oven having such a heating coil is to be specified.

According to the invention, these objects may be achieved by a heating coil that is designed in accordance with one or more embodiments described herein.

In a known manner, the heating coil comprises a heat source, which in itself can be of any design. For example, a heating spiral or an arrangement of heating rods acts as a heat source. These are preferably made of a metal with good thermal conductivity, such as, among others, copper or aluminum, and have an electric current of the desired strength flowing through them for the emission of heat or energy. The heat source can also be designed as a pipe system through which, for example, hot water flows for the emission of heat. A first fluid flows around the heat source, which fluid absorbs the energy from the heat source as it flows around it. The first fluid is, for example, ambient air, water, or another fluid medium. It can be seen that the heating coil has a housing to guide the first medium in a cold state to the heat source, to cause it to flow around said source, and to discharge it in a heated state for actual use. Furthermore, conveying devices such as pumps or blowers for the first medium are provided, as well as a preferably central controller to regulate, among other things, the delivery rate and delivery pressure of the first medium and the heat output of the heat source.

Furthermore, a cleaning device is provided which comprises a nozzle pipe from which a cleaning fluid emerges which is directed onto the heat source. The cleaning fluid also flows around the heat source and in so doing cleans its outer surface of deposits or soiling. The cleaning fluid is at a higher pressure than the first fluid in order to effectively clean the heat source. In particular, pressurized air emerging from a nozzle pipe is directed onto the heat source, with the pressurized air emerging from nozzles on the nozzle pipe, wherein the nozzles are arranged in a line along the nozzle pipe. The increased pressure ensures that even during running operation with the first fluid flowing, the cleaning fluid strikes the outer surface of the heat source with sufficient speed and force to clean it.

According to the invention, two lines of nozzles are arranged along the nozzle pipe of the cleaning pipe system, wherein the two lines are radially spaced apart from one another along the nozzle pipe. This means that the cleaning fluid emerges from the nozzle pipe along two lines and the outlet directions of each of the nozzles, which are arranged in a line, point in different directions, seen relative to the nozzle pipe in each case. Here the nozzle pipe with the two lines of nozzles for discharging the cleaning fluid is aligned in such a way that the cleaning fluid emerges toward or is directed onto the heat source. For example, with a horizontally aligned nozzle pipe, one line of nozzles can point obliquely upward and the other obliquely downward, in each case in the direction toward the heat source.

This means that a substantially larger surface of the heat source is supplied with flow with a single nozzle pipe. The cleaning fluid emerging from the nozzle pipe preferably flows over or around the entire surface of the heat source.

The overpressure of the cleaning fluid ensures that the cleaning fluid passes through the actual fluid flow of the first fluid to be heated and strikes the surface of the heat source with sufficient speed and in sufficient quantity to be able to remove impurities there.

The advantage of the invention is that a heat source with a much larger surface can be cleaned of soiling and the like using only a single nozzle pipe. This means that a complex and long cleaning pipe system is not necessary. The pressure and friction losses within a longer cleaning pipe system are also avoided.

Of course, the number, size, and orientation of the nozzles, the mutual distances, in particular of the nozzle pipe from the heat source and of the individual components from one another, the type and pressure of the cleaning fluid, and a corresponding sequence control for a cleaning process are essentially freely selectable within the scope of the invention, according to the requirements of the particular case.

The heating coil with the additional cleaning device is preferably used in a curing oven for mineral wool. Heating coils with electric heating rods as a heat source, arranged in a housing, are known. Conveyed ambient air flows through the housing, thus heating the air. In particular, the freely swirling mineral fibers of a mineral wool provided with a thermally activated binder lead to clogging of the heating coil. This can be prevented by the additional cleaning device. For this purpose, pressurized air is conducted through a cleaning pipe system and exits the nozzle pipe at a nozzle pipe having the nozzles arranged in a line. Due to the arrangement of the lines, the cleaning fluid, in particular pressurized air, which is under a higher pressure than the air to be heated, is directed onto the heat source, which is usually flat. In this way, a large surface area of the heat source can be cleaned.

Of course, such a heating coil can also be used in all other areas of technology. For example, a heating system in which ambient air drawn in is heated to a desired room temperature by heating spirals can be equipped with such a cleaning device. The heat source can also be formed by a pipe system through which fluid flows. Furthermore, the invention also includes the heat source acting alternately or alternatively as a heat sink. This means that, for example, air flowing through flows around a cooling pipe in order to lower the room temperature for air conditioning. The heating coil can be used in all types of heat exchangers, and the first fluid and the cleaning fluid can each be liquid or gaseous, for example. For example, steam heat exchangers, air-to-air heat exchangers, water-to-water heat exchangers, water-to-air heat exchangers, or oil-to-air heat exchangers are conceivable.

Advantageous embodiments of the invention are also described herein.

In a first embodiment of the heating coil, more than two lines of nozzles are formed on the nozzle pipe to discharge the cleaning fluid. For example, three lines are provided. Given a horizontal course of the nozzle pipe, one of these lines is aligned directly, for example substantially horizontally, in the direction toward the heat source, and one line is aligned obliquely upward and one is aligned obliquely downward. Four or five lines can also be formed.

A preferred further development of the heating coil proposes that two or more nozzle pipes are provided. If the heat source has a large surface area, more than two nozzle pipes may be required to completely cover the entire surface with cleaning fluid.

It is also proposed that the cleaning device be operable in pulsed mode. For example, for this purpose valves in a cleaning pipe system can be opened and closed with an appropriate controller in order to carry out a cleaning process in a clocked manner, for example. This can be carried out at adjustable and selectable time intervals, for the desired duration each time.

A pressure tank is provided to achieve sufficient pressure of the cleaning fluid. For example, pressurized air is stored in a pressure vessel, which is then introduced into the cleaning pipe system in pulsed fashion in order to clean the heat source with blasts of air. Of course, there is also a corresponding pressure pump for filling the pressure tank.

To enable automatic cleaning, the cleaning device is equipped with one or more sensors. For example, a sensor measures the quantity of the first fluid conveyed through the heating coil and/or the sensor detects the temperature of the heated first fluid and/or a degree of efficiency of the heating coil is detected and/or an optical monitoring of the heat source is carried out using image processing or the like. If soiling of the heating coil is detected by sensors in this way, the controller can automatically carry out a cleaning or can issue a corresponding request.

Depending on the design or technical necessity, the additional cleaning device with the nozzle pipe with the lines of nozzles for discharging the cleaning fluid can be arranged either before or after the heating coil and, in particular, its heat source, seen in a direction of flow of the first fluid through the heating coil. This means that the cleaning fluid either flows with the first fluid in the direction toward the heat source or with corresponding pressure in the direction opposite that of the first fluid. In principle, if the heat source is dimensioned accordingly, one or more nozzle pipes of this type can also be arranged within the heat source, which is formed for example by a plurality of spaced heating rods or a heating loop.

### BRIEF DESCRIPTION OF THE DRAWINGS

An exemplary embodiment of the invention is explained below with reference to a drawing. The figures in the drawing show:

FIG. 1 a perspective view of a heating coil with a cleaning device,

FIG. 2 a perspective view of the cleaning device,

FIG. 3 a perspective view of a nozzle pipe of the cleaning device, and

FIG. 4 flow directions through the heating coil.

### DETAILED DESCRIPTION OF THE PREFERRED EMBODIMENTS

In the following description of the figures, identical parts in the various purely schematic figures are always provided with the same reference signs, so that not all reference signs need to be explained again for each figure.

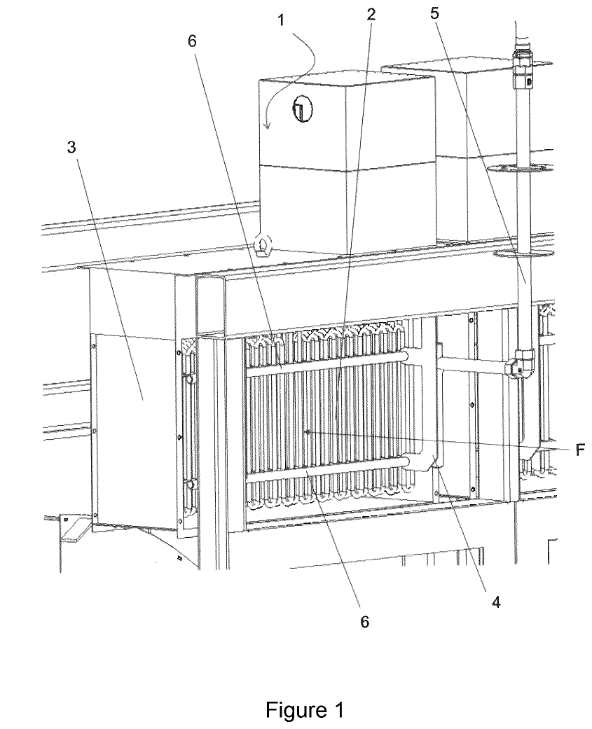

FIG. 1 shows a heating coil 1 comprising a heat source 2 arranged inside a housing 3. The heat source 2 is designed, for example, as an arrangement of heating rods through which current flows, or a heating spiral, or as a pipe system through which a fluid such as hot water flows. A first fluid flows through the heating coil 1, for example ambient air, which is conveyed through the heating coil 1 or the housing 3 in a conveying direction F by pumps, blowers, or the like, and which heats up to the desired extent as it flows around the heat source 2.

Such a heating coil 1 is used for example to heat air in a curing oven for mineral wool sheets, which in turn are mixed with a thermally activatable binder. Passing over or penetrating the mineral wool sheet with heated air activates the binder and gives it the desired consistency. During this, the heat source 2 will unavoidably become increasingly clogged by flying mineral fibers. To remedy this, the heating coil 1 is equipped with a cleaning device 4. This device is made up of a cleaning pipe system 5 with a nozzle pipe 6, in this case two nozzle pipes 6.

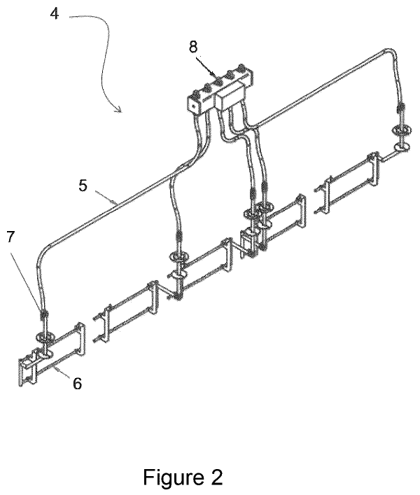

FIG. 2 shows the cleaning device 4 separately. It comprises a cleaning pipe system 5, valves 7, nozzle pipes 6, and a pressure tank 8. Pressurized air, for example, is stored in the pressure tank 8. A pressurized air pump (not shown here) is used for filling. Via a cleaning pipe system 5, this pressurized air is fed to the nozzle pipes 6 in a manner controlled by valves 7. The pressurized air exits there and cleans the heat source 2. It is understood that the filling of the pressure tank 8 and the actuation of the valves 7 can preferably be carried out in a clocked or pulsed manner by a central controller of the cleaning device 4 or of the heating coil 1 or of an overall curing oven.

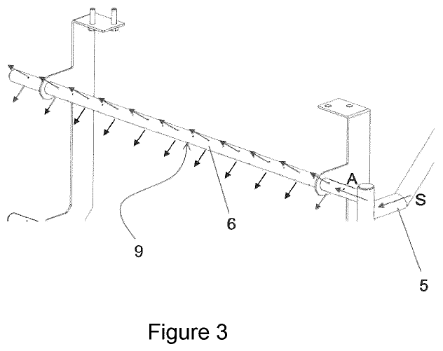

FIG. 3 shows the nozzle pipe 6 of the cleaning device 4 of a heating coil 1 in detail, in particular for use in a curing oven. The nozzle pipe 6 is part of a cleaning pipe system 5 of the cleaning device 4, in particular for conducting pressurized air from a pressure tank 8 in the flow direction S. Two linear rows of nozzles 9 are formed on the nozzle pipe 6. From each of these nozzles 9, the pressurized cleaning fluid emerges from the nozzle pipe 6 in the outflow direction A. Here the two lines are spaced apart radially along the circumference of the nozzle pipe 6. As a result, the cleaning fluid flows out A through the nozzles 9, either obliquely upward or obliquely downward. In this way. a heat source 2 with a larger surface area can be cleaned with only one nozzle pipe 6 or, as can be seen from FIG. 1, two nozzle pipes 6 per heat source 2 are provided there in accordance with the surface area of the heat source 2.

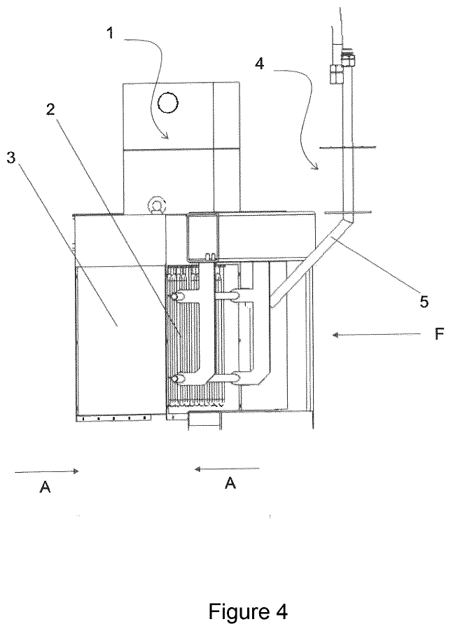

FIG. 4 shows the arrangement of the cleaning device 4 relative to the heating coil 1, here to the right of the heating coil 1. The first fluid, the air to be heated, flows in the direction of flow F through the heating coil 1 or through its housing 3. The cleaning device 4 with the cleaning pipe system 5 or the nozzle pipe 6 is arranged before the heating coil 1 in the direction of flow F and the cleaning fluid flows out of the nozzle pipe 6 toward the heat source 2 in the direction of flow A. In principle, the cleaning device 4 can also be arranged after the heating coil 1 in the direction of flow F; here this would be to the left of the heating coil 1. The cleaning fluid then flows in the outflow direction A′ opposite the conveying direction F, toward the heat source 2. This source gets blown through, so to speak.

Of course, all components, flow rates, pressures, dimensioning, and fluids used can be adapted to the requirements of the particular case. In principle, any heat exchanger can be designed accordingly, and in particular the heat source 2 can additionally or alternatively be designed as a heat sink.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

| Sign | Designation |
|---|---|
| 1 | Heating coil |
| 2 | Heat source of 1 |
| 3 | Housing of 1 |
| 4 | Cleaning device of 1 |
| 5 | Cleaning pipe system of 4 |
| 6 | Nozzle pipe of 4 |
| 7 | Valve of 4 |
| 8 | Pressure tank of 4 |
| 9 | Nozzle on 6 |
| F | Conveying direction of the first fluid |
| S | Flow direction of the cleaning fluid in 5 |
| A | Outflow direction of the cleaning fluid from 6 |

Claimed is:

1. A heating coil, comprising
a heat source for emitting energy, wherein the heating coil is configured so that a first fluid flows around the heat source, and,
a cleaning device having a nozzle pipe with a plurality of nozzles, wherein the cleaning device is configured so that a cleaning fluid emerges from the nozzles under overpressure compared to the first fluid and flows around the heat source to clean the heat source, the nozzles being arranged in a line along the nozzle pipe of the cleaning device,
wherein the nozzles are arranged on the nozzle pipe in at least two lines along the nozzle pipe and the at least two lines are spaced radially from one another along the nozzle pipe.

2. The heating coil according to claim 1, wherein more than two lines of nozzles are formed on the nozzle pipe.

3. The heating coil according to claim 1, wherein the cleaning device has two or more nozzle pipes.

4. The heating coil according to claim 1, wherein the cleaning device is configured to be operated in a pulsed fashion.

5. The heating coil according to claim 1, wherein the cleaning device has a pressure tank for the cleaning fluid.

6. The heating coil according to claim 1, wherein the cleaning device has a sensor for detecting a soiling of the heat source.

7. The heating coil according to claim 1, wherein the cleaning device is arranged, relative to a conveying direction of the first fluid, before or after the heat source.

8. An oven for a material web to be treated with heat in a continuous pass-through process, the oven comprising:
the heating coil according to claim 1.
